(19) United States
(12) Patent Application Publication
(10) Pub. No.: US 2006/0196705 A1
(43) Pub. Date: Sep. 7, 2006

(54) Load cell with folded arm bending beam

(75) Inventor: Randall K. Hopkins, Mendon, MA (US)

Correspondence Address: FASSE PATENT ATTORNEYS, P.A., P.O. BOX 726, HAMPDEN, ME, 04444-0726, US

(73) Assignee: Hottinger Baldwin Measurements, Inc., Marlboro, MA (US)

(21) Appl. No.: 11/071,397

(22) Filed: Mar. 2, 2005

(51) Int. Cl. G01G 3/08

(52) U.S. Cl. 177/229

(57) ABSTRACT

A load cell bending beam includes a mounting block, a sensing arm, and a load receiving arm connected in succession, and preferably integrally, to one another. The mounting block is to be secured onto a reference support. The load receiving arm is “folded back” under the sensing arm, so the two arms extend respectively along two substantially parallel planes that are spaced apart from one another. A load to be measured is introduced through a clearance hole in the sensing arm onto the load receiving arm, so as to deflect the load receiving arm and therewith the sensing arm. Strain gages arranged on remaining flexure beams of the sensing arm beside the clearance hole measure the resulting strain. The bending beam has a low profile height and is preferably machined from a single monolithic block of metal with a narrow slot (e.g. less than 0.1 inch) separating the two arms.

### FIELD OF THE INVENTION

The invention relates to a load cell with strain gages arranged on a bending beam structure, as well as such a bending beam structure and a weighing scale incorporating such a load cell.

### BACKGROUND INFORMATION

A load cell generally includes a bending beam structure that is elastically deflected by application of a load that is to be sensed and measured, as well as one or more strain transducers (e.g. strain gages) arranged on the bending beam structure so as to measure the elastic deflection thereof due to the applied load. Particularly, the strain gages exhibit a varying electrical characteristic, e.g. a varying resistance, depending on the strain to which they are subjected. By appropriately evaluating electrical signals provided by or through the strain gages, e.g. by evaluating the varying resistance of the strain gages, it is possible to determine the strain experienced by the strain gage, and in turn therefrom determine the load applied to the bending beam structure to cause such strain. A typical application of such load cells is thus in a weighing scale, to weigh an object placed on the scale by measuring the gravitational load applied by the object to the load cell or load cells of the weighing scale.

Many different structures, configurations, arrangements and particular operation of strain gages are conventionally known. Also, many different configurations, constructions and arrangements of bending beam structures for load cells are conventionally known. It is one goal to make such a bending beam structure as simple as possible, so that the resulting load cell is economical and compact. On the other hand, in order to achieve a high accuracy of the load-measuring, e.g. weighing, result provided by the load cell, it is another goal to provide a configuration of the bending beam structure that achieves a consistent reproducible elastic deflection dependent on and responsive to the applied load in the significant loading direction, while preferably avoiding, constraining, mechanically compensating, or canceling-out undesired or spurious load components, such as a lateral load, a tilting load, a torquing load, an off-axis load, an overturning moment, etc. In order to mechanically avoid influences from such secondary, undesired, or spurious load components, it generally becomes necessary to provide a more complex structure of the bending beam arrangement.

U.S. Pat. No. 5,510,581 (Angel) discloses a flat planar bending beam structure that is cut out of a single flat piece of metal, as well as a load cell that includes plural strain gages arranged on the flat planar bending beam structure. The bending beam structure includes a clamping or mounting member and a load receiving member respectively at opposite ends thereof, connected to each other by two flexure beams that extend parallel to each other. The clamping member includes mounting holes by which the load cell may be mounted by bolts onto a support. The load receiving member includes a load receiving tongue with a bored load receiving hole, for securing a load introduction member to the load receiving tongue. When a load is applied to the load receiving tongue relative to the clamping member, in a direction perpendicular to the plane of the flat bending beam structure, the tongue and the load receiving member will be deflected, while the flexure beams are elastically flexed respectively into a slightly S-shaped cantilevered curve. The strain gages arranged on the flexure beams sense the strain and provide a corresponding electrical output indicative of the load.

By providing the dual parallel flexure beams, the bending beam structure according to the Angel patent is said to resist torsional and eccentric flexing of the respective beams, and to allow lateral load influences to be negated or canceled out in the output signal of the strain gages. Also, the configuration of the bending beam structure on a single flat plane made of a single flat piece of metal allows the overall load cell to be very thin, i.e. have a very small total height.

However, the relatively simple single-plane flat bending beam structure according to the prior art needs further improvement with regard to avoiding or eliminating spurious or secondary load components, and especially an overturning moment, and thus improving the consistent reproducible performance of the load cell.

### SUMMARY OF THE INVENTION

In view of the above, it is an object of the invention to provide a bending beam structure for a load cell, and a corresponding load cell, that improves the mechanical avoidance, rejection, or elimination of secondary spurious load components other than the primary load component that is to be sensed and measured, and that has a very compact height suitable for use in low-profile platform scales. It is a further object of the invention to provide such a bending beam structure that has compact dimensions, and can easily and economically be fabricated preferably from a single block or plate of metal material. The invention further aims to avoid or overcome the disadvantages of the prior art, and to achieve additional advantages, as apparent from the present specification. The attainment of these objects is, however, not a required limitation of the claimed invention.

The above objects have been achieved according to a first aspect of the invention, in a bending beam arrangement for a load cell comprising: a mounting block adapted to be secured to a reference support; an elastically deflectable sensing arm having a fixed end connected to the mounting block and a free end extending away from the mounting block opposite the fixed end; and an elastically deflectable load receiving arm having a supported end connected to and supported by the free end of the sensing arm and a free end extending toward the mounting block opposite the supported end; wherein the sensing arm extends along a first plane, the load receiving arm extends along a second plane, and the first and second planes are spaced apart and substantially parallel to one another; wherein the load receiving arm has a load introduction point adapted to have a to-be-measured load applied thereto relative to the reference support; and wherein the sensing arm has an opening therethrough that exposes the load introduction point of the load receiving arm through the opening.

The above objects have further been achieved according to another aspect of the invention, in a load cell comprising: a mounting block adapted to be secured to a reference support; an elastically deflectable sensing arm that extends along a first plane, and that has a fixed end connected to the mounting block and a free end extending away from the mounting block opposite the fixed end; an elastically deflectable load receiving arm that extends along a second plane substantially parallel to and spaced apart from the first plane, and that has a supported end adjacent to the free end of the sensing arm and an unsupported free end opposite the supported end and adjacent to the fixed end of the sensing arm; a slot having a slot gap thickness in a range from 0.005 inch to 0.1 inch between the load receiving arm and the sensing arm; a junction that bridges and closes an end of the slot and connects the free end of the sensing arm on the first plane with the supported end of the load receiving arm on the second plane; and two strain gage arrangements arranged on an outer surface of the sensing arm opposite from the slot and the load receiving arm; wherein the load receiving arm has a load introduction point adapted to have a to-be-measured load applied thereto relative to the reference support; and wherein the sensing arm has a hole therein that passes through the sensing arm to the slot and exposes the load introduction point of the load receiving arm.

The above objects have still further been achieved according to yet another aspect of the invention, in a load cell comprising a monolithic block of a metal, and first and second strain gage arrangements arranged on the monolithic block. The monolithic block has: a top surface and a bottom surface substantially parallel to one another; mounting holes passing through the block at a first end of the block; a slot comprising a first slot that extends substantially parallel to and between the top surface and the bottom surface, wherein the slot has a slot gap dimension in a range from 0.005 inch to 0.1 inch and separates a lower arm of the block extending along the bottom surface from an upper arm of the block extending along the top surface; a junction portion of the block at a second end of the block opposite the first end, wherein the junction portion is not penetrated by the slot, bridges and closes an end of the slot, and connects the lower arm to the upper arm at the second end of the block, and wherein the lower arm is connected to the upper arm only by the junction portion at the second end, and an unsupported free end of the lower arm extends away from the junction portion toward the first end; and a hole passing through the upper arm from the top surface into the slot to expose the lower arm through the hole. The first and second strain gages are arranged on the top surface of the upper arm respectively on opposite sides of the hole.

As can be seen from the above, a key feature of one aspect of the invention is that the bending beam arrangement has a “folded-back” or “folded-under” arm structure. Namely, the flex beam arrangement includes a sensing arm having opposite fixed and free ends of which the fixed end is connected to the mounting block, as well as a load receiving arm having opposite supported and free ends of which the supported end is connected to the free end of the sensing arm. The sensing arm and the load receiving arm respectively extend on two planes that are substantially parallel and spaced apart relative to each other. In this manner, the load receiving arm is “folded-back” or “folded-under” the sensing arm, and the free end of the load receiving arm extends back toward the fixed end of the sensing arm. Furthermore, the load to be measured is introduced onto the load receiving arm through the pass-through opening or clearance hole provided in the sensing arm. Strain gages may be mounted on the flexure beams formed by the remaining material of the sensing arm on opposite sides of the clearance hole.

According to another significant aspect of the invention, the bending beam arrangement is machined from a single monolithic plate or block of metal material, by forming a slot to separate the load receiving arm from the sensing arm, and forming the pass-through opening through the sensing arm so as to expose the underlying load receiving arm and form a clear load introduction path through the sensing arm to the load receiving arm. The slot preferably consists of a first slot extending parallel to the major plane of the overall bending beam arrangement, and a second slot extending perpendicularly to the first slot. Alternatively, a single planar slot can be sufficient to separate the load receiving arm if the mounting block is offset and thus separated from the load receiving arm. These slots may be easily formed by conventional mechanical machining processes, such as sawing, milling or routing, or may be formed by wire electron discharge machining (EDM), or still further alternatively may be formed by water jet cutting.

The slot separating the load receiving arm from the sensing arm is a significant feature of the invention, especially because the slot preferably has a very small slot gap height or thickness, e.g. from 0.005 to 0.1 inch (0.127 to 2.54 mm), or preferably from 0.01 or 0.02 to 0.06 inch. As a result, the overall height dimension of the bending beam and of the finished load cell can be made very compact, e.g. preferably less than 0.5 inch total height, so that the load cell is suitable for use in low-profile platform scales. When the load cell is to be used only for loads causing a downward deflection of the load receiving arm, then the minimum slot gap dimension is limited only by the technological ability to make the narrowest slot possible. On the other hand, if the load cell is to be used for loads deflecting the load receiving arm toward the sensing arm, then the slot gap must be sufficient to allow the maximum deflection of the load receiving arm and thereafter act as a maximum deflection limit or stop when the deflection of the load receiving arm “closes the gap” of the slot. In this regard, the typical deflection range of the load receiving arm is ±0.01 to 0.025 inch.

The metal material forming the monolithic bending beam arrangement with its integral load receiving arm, sensing arm, and mounting lug or block is preferably an aluminum alloy, most preferably 2024-T351 aluminum, or alternatively any other suitable metal material, such as a stainless steel or a titanium alloy. The inventive bending beam structure can be very economically and easily fabricated from a single monolithic plate or block of such a metal material using relatively simple machining processes such as hole boring, and slot sawing or EDM machining, for example. Thus, the resulting load cell is economical.

As a further advantage, the “folded-back” or “folded-under” configuration of the load receiving arm, extending from the sensing arm on a second plane below the plane of the sensing arm, achieves a significantly improved performance of the load cell. Most importantly, the folded arm structure ensures that the sensing arm acts as a fixed-fixed bending beam rather than a simple cantilever beam, and thus eliminates the torquing, tilting, or overturning moment being applied to the bending beam structure. Namely, the intended downward primary load component is measured, while other loading components or load directions are resisted, absorbed, or eliminated by the flexing of the folded-under load-receiving arm.

Since the connection or joint between the load receiving arm and the sensing arm extends continuously across the entire width of the bending beam structure, this provides substantial strength and stability against torquing or tilting moments. The same is further true because of the solid extension of the load receiving arm across the entire width of the bending beam structure. The load receiving arm applies a downward suspended load, and also applies a pivoting effect on the junction, in an opposite direction relative to a pivoting effect due to the downward deflection of the sensing arm, so that the junction may remain e.g. “horizontal” or non-pivoting, and the sensing and load receiving arms undergo a slightly S-shaped deflection as a result. By eliminating the overturning moment, this dramatically improves the measuring performance of the load cell, because this serves to equalize the stresses and thus the strains exerted on the two flexure beams of the sensing arm at the locations of the strain gages.

### BRIEF DESCRIPTION OF THE DRAWINGS

In order that the invention may be clearly understood, it will now be described in connection with example embodiments thereof, with reference to the accompanying drawings, which are not to scale, wherein:

FIG. 1 is a schematic top plan view of a bending beam structure according to a first embodiment of the invention, with dashed lines showing internal hidden features;

FIG. 2 is a schematic side view of the bending beam structure according to FIG. 1, with dashed lines showing hidden internal features;

FIG. 3 is a schematic top plan view of a load cell according to another embodiment of the invention, including strain gages mounted on a bending beam structure having slightly different dimensions and proportions in comparison to FIGS. 1 and 2;

FIG. 4 is a schematic side view of the load cell according to FIG. 3;

FIG. 5 is a schematic top plan view of a load cell according to a further embodiment of the invention;

FIG. 6 is a schematic side view of the load cell according to FIG. 5; and

FIG. 7 is a schematic side view of a weighing scale including a load cell according to the invention installed therein, whereby the view has been partially broken open or sectioned to show the components.

### DETAILED DESCRIPTION OF PREFERRED EXAMPLE EMBODIMENTS AND OF THE BEST MODE OF THE INVENTION

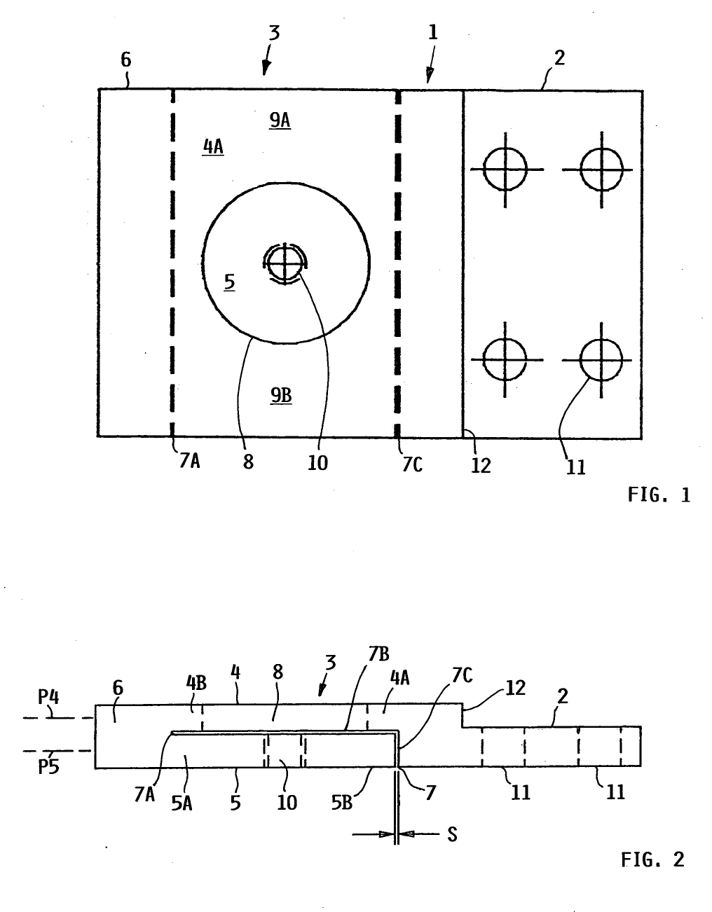

FIGS. 1 and 2 show top and side views of a structure and configuration of a load cell bending beam 1 according to a first embodiment of the present invention. In general, a load cell bending beam is to have one part thereof fixed to a reference support, and another part thereof subjected to a load that is to be measured, such that the load elastically deflects the bending beam, whereupon strain gages arranged on the bending beam can measure the resulting strain so as to measure the applied load. In this regard, the present bending beam 1 includes a mounting lug or block 2 as well as a flex beam structure embodied as a folded-back arm structure 3. The mounting block 2 has plural mounting holes 11, whereby the bending beam 1 may be secured with bolts to a reference support. The folded-back arm structure 3 includes a sensing arm 4 connected to and extending from the mounting block 2, and a load receiving arm 5 connected to and “folded-back” or “folded-under” relative to the sensing arm 4.

More particularly, a fixed end 4A of the sensing arm 4 is connected to the mounting block 2 via a stepped-up shoulder 12, whereby the top plane of the sensing arm 4 is somewhat higher than the top plane of the main body of the mounting block 2. This allows for a somewhat recessed arrangement of the mounting bolt heads relative to the top surface of the sensing arm 4. A free end 4B of the sensing arm 4 protrudes longitudinally opposite and away from the fixed end 4A, and is free to be elastically deflected. A supported end 5A of the load receiving arm 5 is connected to and supported by the free end 4B of the sensing arm 4 through a “folded” junction 6. From there, the load receiving arm 5 extends longitudinally back toward the mounting block 2 under the sensing arm 4 and terminates at a free end 5B adjacent to the mounting block 2. Thus, the sensing arm 4 and the load receiving arm 5 extend respectively on two (e.g. horizontal) central planes P4 and P5 that are substantially parallel, yet (e.g. vertically) offset or spaced apart relative to each other. The term “substantially” parallel allows for some non-parallel flexing of the bending beam structure in operation, as well as manufacturing tolerances and the like, and permits deviations from true exact parallelism, for example, within 50, or preferably 30 or more preferably less than 10 from true parallelism. In the present embodiment, the bottom surface of the load receiving arm 5 is aligned coplanar with the bottom surface of the mounting block 2 in an unloaded condition, while the top surface of the sensing arm 4 is slightly higher than the top surface of the mounting block 2 as discussed above. Preferably, the entire bending beam 1 including the mounting block 2, the sensing arm 4 and the load receiving arm 5, is fabricated from a single monolithic plate or block of a metal material, preferably an aluminum alloy, and particularly 2024-T351 aluminum, or alternatively another suitable metal alloy such as stainless steel or a titanium alloy. With such a monolithic structure, the mounting block 2, the sensing arm 4, and the load receiving arm 5 are integrally and continuously joined with one another in succession.

The load receiving arm 5 is separated from the sensing arm 4 simply by forming a narrow slot 7 therebetween. This slot 7 passes continuously through the entire width or lateral dimension of the bending beam 1, and may preferably include a first planar slot 7B extending parallel to the major plane of the bending beam 1, and a second planar slot 7C extending perpendicularly to the first planar slot 7B. Note that the slot 7 is a very narrow slot, which is a significant feature of the invention. For example, the slot has a slot gap in a range from about 0.005 to about 0.1 inches, preferably about 0.01 or 0.02 to about 0.06 inches for most applications. This slot 7, i.e. the component slots 7B and 7C, can be formed by any known machining techniques. Preferably, wire electron discharge machining (EDM) has been used effectively to form the very narrow and consistent slot. Mechanical machining processes such as sawing, routing, and milling have also been used effectively, especially when a somewhat wider slot is suitable for a particular embodiment. As a further alternative, water jet cutting has been used as another option for forming the slot 7. In any event, the slot 7 preferably terminates at a rounded or eased end 7A, with a suitable radius of curvature to avoid or reduce stress concentration that could otherwise form a crack initiation site at the slot end due to the loading and deflection of the load receiving arm 5.

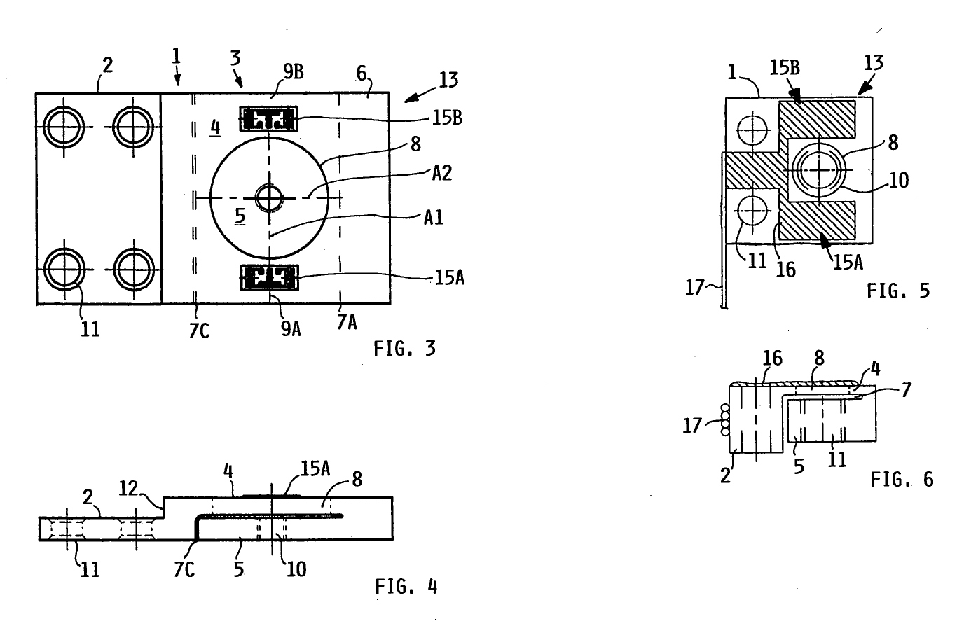

The sensing arm 4 has a load introduction pass-through opening or clearance hole 8 passing through the entire thickness of the sensing arm 4 to the slot 7, so as to expose the underlying load receiving arm 5. Preferably, the clearance hole 8 is a simple circular bored or milled hole passing vertically through the thickness of the sensing arm 4. The load introduction opening or clearance hole 8 is formed centered in the width direction of the sensing arm 4, so as to form two flexure beams 9A and 9B of the remaining material of the sensing arm 4 symmetrically on opposite sides of the clearance hole 8. The flexure beams 9A and 9B extend longitudinally to connect the fixed end 4A to the free end 4B of the sensing arm 4 around the clearance hole 8. The flexure beams 9A and 9B will also serve as the load sensing elements, in that strain gages will be arranged on these flexure beams 9A and 9B (as discussed below in connection with FIGS. 3 to 6) in order to sense and measure the strain exhibited by the flexure beams 9A and 9B upon application of a load to the load receiving arm 5.

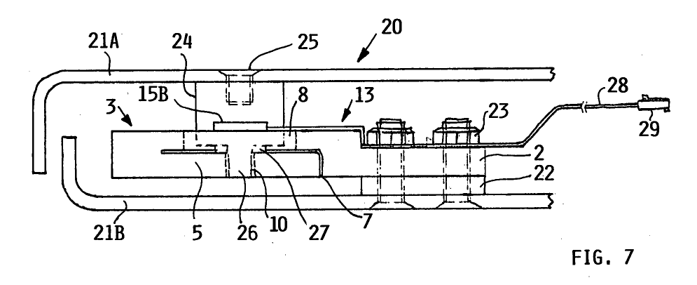

The load to be measured is applied to the load receiving arm 5, preferably through the load introduction pass-through opening or clearance hole 8. This load introduction is achieved by a load introduction stud or the like (see the following discussion regarding FIG. 7) that passes through the clearance hole 8 without contacting the sensing arm 4, and bears or rests on the exposed underlying load receiving arm 5. In order to securely fix the load introduction stud to the load receiving arm 5 at the proper load introduction point, a load introduction fixture hole 10, which is preferably threaded, is formed in the load introduction arm 5 in axial alignment with the pass-through opening or clearance hole 8. Thus, the load introduction stud or fixture can be threaded into, or screwed or bolted to, the threaded fixture hole 10, to be securely fixed to the load receiving arm 5.

The load applied via the load introduction stud can be downwardly and/or upwardly directed. As a further alternative, instead of bearing down from above the bending beam 1, the load to be measured can be suspended below the bending beam 1. In this case, a load fixture is threaded into or bolted to the fixture hole 10 on the bottom of the load receiving arm 5, and the load is suspended from the load fixture. The clearance hole 8 provides access for securing the fixing bolt or the like. Other orientations of the load cell are also possible (e.g. “upside down”, or extending vertically or along an incline). In the orientation shown in FIG. 2, with the major plane of the bending beam 1 extending horizontally, and with the load receiving arm 5 below the sensing arm 4, the bending beam operates as follows. The load introduction fixture or stud secured to the threaded hole 10 applies a load, e.g. a gravitational weight load that is to be measured, to the load receiving arm 5, by passing through the clearance hole 8 without contacting the sensing arm 4. This downward load causes the load receiving arm 5 to elastically deflect downwardly, either in a pivoting or tilting manner about the area of the slot end 7A and the folded junction 6 if the load introduction stud is not constrained against tilting, or with a slightly S-curved configuration if the load introduction stud is constrained against tilting (which is the usual condition). In any event, any tilting, torquing, off-axis, or overturning moments are substantially isolated from the sensing arm 4, and instead essentially only a pure downward deflecting load of the fixed-fixed bending beam type is applied from the load receiving arm 5 through the folded junction 6 to the free end 4B of the sensing arm 4.

More particularly, the downward deflection of the load receiving arm 5 also exerts a levering or pivoting moment on the folded junction 6, which tends to keep the folded junction 6 itself in its initial horizontal orientation. In other words, the sensing arm 4 does not simply deflect in a uniform curve downwardly (as a simple cantilever beam would), but rather curves with a slight S-shape between the substantially horizontal top surface of the fixed end 4A adjacent to the stepped-up shoulder 12 and the substantially horizontal top surface of the free end 4B and the adjoining folded junction 6. Thus, the sensing arm 4 acts as a fixed-fixed bending beam, as discussed above.

The downward deflection of the sensing arm 4 places the central portion of the top surface of the flexure beams 9A and 9B under tension, whereby the top surface of these beams 9A and 9B exhibits a positive strain that can be measured by the applied strain gages (to be discussed below). The broad full-width connection of the load receiving arm 5 to the sensing arm 4 through the folded junction 6 also helps to distribute and even-out the load applied to the sensing arm 4, so that the two symmetrical flexure beams 9A and 9B are also symmetrically loaded.

For a typical application of the bending beam 1 according to FIGS. 1 and 2, the overall bending beam 1 may have a total length in the longitudinal direction of about 3.3 inches, a width of about 2.2 inches, a total thickness or height of about 0.4 inches, a thickness of the mounting block of about 0.25 inches, a diameter of the clearance hole 8 of about 1 inch, a slot length of the horizontal slot 7B of about 1.4 inches, a slot gap width or height S of about 0.02 inches along the entire slot, and a radius of curvature of the slot end 7A of a minimum of 0.009 inches, while the sensing arm has a thickness of about 0.17 inches and the load receiving arm has a thickness of about 0.21 inches. These dimensions are all merely exemplary for a particular preferred application, but can be varied as needed in broad ranges for various load capacities, various applications, and/or various installations. In all cases, the total thickness or height of the bending beam 1 can be less than 0.5 inch, so that the overall load cell is very compact in the height or thickness direction. Also, it should be understood that the number, arrangement, and dimensions of the mounting holes 11 and the threaded load introduction fixture hole 10 can be provided as needed for any particular application.

Now turning to FIGS. 3 and 4, a bending beam 1 similar to that shown and discussed above in connection with FIGS. 1 and 2 (merely with slightly different dimensions of various components) has two strain gage arrangements 15A and 15B mounted or affixed thereon to form a load cell 13. Each strain gage arrangement 15A and 15B may include one or more individual strain transducers or strain gages, such as foil-type resistor strain gages, in any conventionally known structure and configuration. The strain gage arrangements 15A and 15B are affixed, e.g. adhesively bonded, onto the top surface of the flexure beams 9A and 9B of the sensing arm 4. Preferably, the strain gage arrangements 15A and 15B are each configured and positioned symmetrically about a transverse first axis Al (neutral axis), and are configured and positioned symmetrically to each other with respect to a longitudinal second axis A2, whereby these axes intersect each other at the vertical axis of the clearance hole 8 and the load introduction fixture hole 10. Due to this symmetrical arrangement, the strain signals provided by the individual strain gages can be readily electrically evaluated to provide high-precision load measurement results. The load introduction to the load cell 13 is by a load introduction fixture or stud passing through the clearance hole 8 and bearing on the load receiving arm 5, in the manner already discussed above in connection with FIGS. 1 and 2.

FIGS. 5 and 6 show another embodiment of a load cell 13 including strain gages 15A and 15B mounted on the sensing arm 4 of a bending beam 1 having a somewhat different configuration than that of FIGS. 1 and 2 or FIGS. 3 and 4. In this embodiment, note that there is no stepped-up shoulder, but rather the top surface of the mounting block 2 is aligned flush and coplanar with the top surface of the sensing arm 4, while the bottom of the mounting block 2 extends below the bottom of the load receiving arm 5. Also note that the sensing arm 4 is extremely thin in comparison to the thickness of the load receiving arm 5, and there is not so great a disparity between the diameters of the clearance hole 8 and the fixture hole 10, in comparison to the embodiments discussed above. For example, in the present embodiment, the overall bending beam 1 may have lateral dimensions (length and width) of 0.9 inches, the mounting block 2 may have a total height or thickness of 0.45 inches and a width or length in the longitudinal direction of 0.2 inches, the sensing arm 4 may have a thickness of about 0.07 inches, the slot 7 may have a thickness of about 0.06 inches, and the load receiving arm 5 can have a thickness from about 0.25 to 0.4 inches as needed for a secure fixing of the load introduction stud.

In FIGS. 5 and 6, the strain gage arrangements 15A and 15B are not directly visible, because they have been covered by a protective covering or encapsulant 16, e.g. a resin covering layer and/or a metal film covering layer. FIGS. 5 and 6 further show a multi-conductor flat ribbon cable 17 that is connected to the strain gage arrangements 15A and 15B, and leads out the strain gage signals from the load cell 13, to be connected to suitable evaluating circuitry (not shown).

An example of a weighing scale 20 incorporating a load cell 13 according to the invention is schematically shown in FIG. 7. The scale 20 includes a top scale housing shell or plate 21A and a bottom scale housing shell or plate 21B. The bottom plate 21B acts as a reference support or base plate that is taken as a stationary reference, and the top plate 21A serves as a live load introduction plate, for example the top surface of the scale onto which an object to be weighed is placed. The mounting block 2 of the load cell 13 is securely mounted and fixed by mounting bolts 23 or the like to the bottom or base plate 21B, with a shim plate 22 interposed therebetween if necessary. Alternatively, the base plate 21B includes a slightly elevated pedestal casting 22, on which the load cell is to be mounted. The shim plate or pedestal casting 22 has a sufficient thickness to provide the necessary deflection clearance for the load receiving arm 5 deflecting downwardly under the applied load (e.g. to accommodate a deflection of 0.01 to 0.025 inch). Note that the scale may include a plurality, e.g. three or four, of such load cells 13 supporting the top plate 21A relative to the bottom plate 21B.

The load to be measured is introduced to the load cell 13 via a load introduction stud 24 that is fastened to the top plate 21A by a fixing screw 25, for example. The stud 24 supports the top plate 21A and any object placed thereon, and introduces the load thereof downwardly through the clearance hole 8 onto the load receiving arm 5. For this purpose, a threaded stud end 26 of the load introduction stud 24 is screwed into the threaded fixture hole 10, and a washer or load introduction disk 27 is provided between a circumferential shoulder or rim of the body of the stud 24 and the load receiving arm 5. Thus, the live load bearing on the stud 24 is transmitted through the washer or disk 27 and through the threaded stud end 26 into the load receiving arm 5, particularly into the perimeter or rim around the fixture hole 10. This deflects the flex beam structure 3 as discussed above, whereby the resulting strain is measured by the strain gages to provide corresponding electrical signals via a wiring harness or cable 28 to an electrical connector plug 29, which may be connected to any suitable evaluating circuitry.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

What is claimed is:

1. A bending beam arrangement for a load cell comprising:
a mounting block adapted to be secured to a reference support;
an elastically deflectable sensing arm having a fixed end connected to said mounting block and a free end extending away from said mounting block opposite said fixed end; and
an elastically deflectable load receiving arm having a supported end connected to and supported by said free end of said sensing arm and a free end extending toward said mounting block opposite said supported end;
wherein:
said sensing arm extends along a first plane, said load receiving arm extends along a second plane, and said first and second planes are spaced apart and substantially parallel to one another;
said load receiving arm has a load introduction point adapted to have a to-be-measured load applied thereto relative to the reference support; and
said sensing arm has an opening therethrough that exposes said load introduction point of said load receiving arm through said opening.

2. The bending beam arrangement according to claim 1, wherein said first and second planes are substantially parallel to one another in an unloaded condition of said bending beam arrangement without the load applied to said load receiving arm.

3. The bending beam arrangement according to claim 1, wherein said opening is axially aligned with said load introduction point.

4. The bending beam arrangement according to claim 1, wherein said load introduction point comprises a load introduction fixture hole in said load receiving arm and a perimeter rim of said load receiving arm around said fixture hole.

5. The bending beam arrangement according to claim 4, wherein said fixture hole is internally threaded.

6. The bending beam arrangement according to claim 4, further comprising a load introduction stud that is secured to said fixture hole in said load receiving arm, extends from said load receiving arm through said opening of said sensing arm, and protrudes outwardly away from said sensing arm.

7. The bending beam arrangement according to claim 6, further comprising a load introduction disc interposed in a load transmitting manner between a shoulder or end face of said load introduction stud and said perimeter rim of said load receiving arm.

8. The bending beam arrangement according to claim 1, wherein said opening is a circular hole.

9. The bending beam arrangement according to claim 1, further comprising a junction that bridges between and connects said free end of said sensing arm on said first plane with said supported end of said load receiving arm on said second plane.

10. The bending beam arrangement according to claim 9, wherein said junction extends laterally along and continuously interconnects an entire width of said sensing arm and an entire width of said load receiving arm.

11. The bending beam arrangement according to claim 1, wherein said sensing arm and said load receiving arm both have the same total width in a transverse direction perpendicular to a longitudinal direction extending from said fixed end to said free end of said sensing arm.

12. The bending beam arrangement according to claim 1, wherein said load receiving arm has side edges aligned in registration with side edges of said sensing arm.

13. The bending beam arrangement according to claim 1, comprising a single monolithic piece of a metal material, including said mounting block, said sensing arm and said load receiving arm integrally interconnected and integrally formed as respective portions of said single monolithic piece.

14. The bending beam arrangement according to claim 1, wherein said mounting block, said sensing arm and said load receiving arm all consist of an aluminum alloy.

15. The bending beam arrangement according to claim 1, further having a first slot that extends substantially parallel to said plane between said sensing arm and said load receiving arm, and that separates said load receiving arm from said sensing arm.

16. The bending beam arrangement according to claim 15, wherein said slot has a slot gap dimension in a range from 0.005 inch to 0.1 inch between said load receiving arm and said sensing arm.

17. The bending beam arrangement according to claim 15, further having a second slot that extends perpendicularly to and communicates with said first slot, and that separates said load receiving arm from said mounting block.

18. The bending beam arrangement according to claim 1, wherein a top major surface of said sensing arm is coplanar flush with a top major surface of said mounting block, and a bottom major surface of said load receiving arm is not coplanar flush with a bottom major surface of said mounting block.

19. The bending beam arrangement according to claim 1, wherein a top major surface of said sensing arm is not coplanar flush with a top major surface of said mounting block, and a bottom major surface of said load receiving arm is coplanar flush with a bottom major surface of said mounting block.

20. A load cell comprising the bending beam arrangement according to claim 1 and first and second strain gage arrangements disposed on said sensing arm, wherein said sensing arm includes first and second flexure beams extending in a longitudinal direction from said fixed end to said free end of said sensing arm respectively on opposite sides of said opening, and wherein said first and second strain gage arrangements are respectively arranged on said first and second flexure beams on an outer surface thereof oriented away from said load receiving arm.

21. The load cell according to claim 20, wherein said flexure beams are each symmetrical about a transverse axis extending perpendicularly to said longitudinal direction through a center axis of said opening, said first and second flexure beams are symmetrical to each other about a longitudinal axis extending in said longitudinal direction through said center axis of said opening, said first and second strain gage arrangements are each symmetrical about said transverse axis, and said first and second strain gage arrangements are symmetrical to each other about said longitudinal axis.

22. A weighing scale comprising the load cell according to claim 20, a base plate being said reference support, a top plate, and a load introduction stud, wherein:
said mounting block is secured to said base plate, and said bending beam arrangement is oriented with said sensing arm above said load receiving arm; and
said load introduction stud is secured to said top plate, extends from said top plate through said opening of said sensing arm to said load receiving arm below said sensing arm, and bears in a load transmitting manner on said load introduction point of said load receiving arm.

23. The weighing scale according to claim 22, wherein said load introduction point includes a threaded hole in said load receiving arm, said load introduction stud includes a threaded stud end, and said threaded stud end is screwed into said threaded hole to secure said load introduction stud to said load receiving arm.

24. The weighing scale according to claim 23, further comprising a load transmission disc interposed in a load transmitting manner between a circumferential shoulder of said load introduction stud and a circumferential rim around said threaded hole in said load receiving arm.

25. A load cell comprising:
a mounting block adapted to be secured to a reference support;
an elastically deflectable sensing arm that extends along a first plane, and that has a fixed end connected to said mounting block and a free end extending away from said mounting block opposite said fixed end;
an elastically deflectable load receiving arm that extends along a second plane substantially parallel to and spaced apart from said first plane, and that has a supported end adjacent to said free end of said sensing arm and an unsupported free end opposite said supported end and adjacent to said fixed end of said sensing arm;
a slot having a slot gap thickness in a range from 0.005 inch to 0.1 inch between said load receiving arm and said sensing arm;
a junction that bridges and closes an end of said slot and connects said free end of said sensing arm on said first plane with said supported end of said load receiving arm on said second plane; and
two strain gage arrangements arranged on an outer surface of said sensing arm opposite from said slot and said load receiving arm;
wherein said load receiving arm has a load introduction point adapted to have a to-be-measured load applied thereto relative to the reference support; and
wherein said sensing arm has a hole therein that passes through said sensing arm to said slot and exposes said load introduction point of said load receiving arm.

26. A load cell comprising:
(a) a monolithic block of a metal having:
a top surface and a bottom surface substantially parallel to one another;
mounting holes passing through said block at a first end of said block;
a slot comprising a first slot that extends substantially parallel to and between said top surface and said bottom surface, wherein said slot has a slot gap dimension in a range from 0.005 inch to 0.1 inch and separates a lower arm of said block extending along said bottom surface from an upper arm of said block extending along said top surface;
a junction portion of said block at a second end of said block opposite said first end, wherein said junction portion is not penetrated by said slot, bridges and closes an end of said slot, and connects said lower arm to said upper arm at said second end of said block, wherein said lower arm is connected to said upper arm only by said junction portion at said second end, and wherein an unsupported free end of said lower arm extends away from said junction portion toward said first end; and
a hole passing through said upper arm from said top surface into said slot to expose said lower arm through said hole; and
(b) first and second strain gages arranged on said top surface of said upper arm respectively on opposite sides of said hole.
